(19) United States
(12) Patent Application Publication
(10) Pub. No.: US 2009/0224595 A1
(43) Pub. Date: Sep. 10, 2009

(54) SEAT BELT EXTENSION DEVICE

(76) Inventor: Craig A. Pfefferman, Simi Valley, CA (US)

Correspondence Address: DOBRUSIN & THENNISCH PC, 29 W LAWRENCE ST, SUITE 210, PONTIAC, MI, 48342, US

(21) Appl. No.: 12/392,444

(22) Filed: Feb. 25, 2009

Related U.S. Application Data
(60) Provisional application No. 61/035,137, filed on Mar. 10, 2008.

(51) Int. Cl. B60R 22/00; B32B 37/00

(52) U.S. Cl. 297/468; 156/66

(57) ABSTRACT

The present invention provides a resilient seat belt extension device comprising: a female receptacle adapted to engage a seat belt system's male buckle; a male buckle adapted to engage a seat belt system's female receptacle; and a resilient connector fixedly attached to the female receptacle on one end and the male buckle on another end; wherein the connector is formed by the following steps: (i) attaching ends of an elongated material together to form the connector with two layers of elongated material; (ii) placing a non-liquid compound between the two layers of elongated material wherein the compound is adapted to provide resiliency to the connector; (iii) attaching the two layers of elongated material together; and (iv) curing the compound at a predetermined temperature. The present invention also provides a method of making the above-described device.

### CLAIM OF BENEFIT OF FILING DATE

This application claims the benefit of U.S. Provisional Application Ser. No. 61/035,137 titled: “Seat Belt Extension Device” filed on Mar. 10, 2008.

### FIELD OF THE INVENTION

The present invention relates to the field of seat belts, more specifically to a resilient seat belt extension device that extends the location of the connection of a female receptacle and a male buckle of a conventional seat belt system towards center of the user's body.

### BACKGROUND OF THE INVENTION

Conventional seat belt systems generally place the seat belt buckle very close to the seat surface. This design creates accessibility problems as the seat belt buckle is often hard to locate. This is especially true for large individuals, individuals with dexterity problems, and law enforcement officers whom need to get in and out of the car in an expedited manner. These accessibility problems also are present for users of child safety seats and individuals sitting side by side of each other.

The conventional seat belt systems also present another problem for law enforcement officers in that the soft and flexible seat belt often tangles up with their gun, making it difficult for the officers to disengage from the seat belt. Hence, it is common for law enforcement officers to not wear a seat belt. This tangling problem also exists for individuals carrying other objects (e.g., cell phone, Blackberry®, personal digital assistant (“PDA”), etc.).

### SUMMARY OF THE INVENTION

The present invention provides a resilient seat belt extension device that solves the above-described problems associated with conventional seat belt systems. The device includes a female receptacle, a male buckle, and a resilient connector fixedly attached to the female receptacle on one end and the male buckle on another end, wherein (i) the female receptacle is adapted to engage a seat belt system's male buckle; (ii) the male buckle adapted to engage the seat belt system's female receptacle; and (iii) the connector is formed by the following steps: (a) attaching ends of an elongated material together forming the connector with two layers of elongated material; (b) placing a non-liquid compound between the two layers of elongated material wherein the compound is adapted to provide resiliency to the connector; (c) attaching the two layers of elongated material together; (d) curing the compound at a predetermined temperature. It is preferred that the female receptacle and the male buckle are adapted to be attached to the connector by looping the elongated material through each of them before the ends of the elongated material are attached together.

The connector provides the device with the following resilient characteristics: The device, when engaged to the seat belt system's female receptacle but not engaged with the seat belt system's male buckle, has sufficient stiffness that it would not fall onto the seat and/or floor; but instead, it would be in a relatively erect position. The device, when engaged both to the seat belt system's male buckle and female receptacle, has sufficient compliance that it would bend and form around a user's body. Once the device is disengaged from the seat belt system's male buckle but is still connected to the seat belt system's female receptacle, the device recovers its relatively erect position allowing it to be easily located when needed.

The present invention also presents a method of making the above-described device comprising: (i) providing a female receptacle adapted to engage a seat belt system's male buckle; (ii) providing a male buckle adapted to engage the seat belt system's female receptacle; (iii) providing an elongated material; (iv) looping the elongated material through an opening of the female receptacle; (v) looping the elongated material through an opening of the male buckle; (vi) attaching ends of the elongated material together forming the connector having two layers of elongated material; (vii) fixedly attaching the female receptacle at one end of the connector and the male buckle at another end of the connector; (viii) placing a non-liquid compound between the layers of elongated material wherein the compound is adapted to provide resiliency to the connector; (ix) attaching the two layers of elongated material together; and (x) curing the compound at a predetermined temperature.

### BRIEF DESCRIPTION OF THE DRAWINGS

The features and inventive aspects of the present invention will become more apparent upon reading the following detailed description, claims, and drawings, of which the following is a brief description:

FIG. 1 illustrates an isometric rendering of an embodiment of a device in accordance to the principles of the present invention and how it connects to a conventional three-point seat belt system being used by a passenger seating in a seat within a vehicle;

FIG. 2 illustrates an isometric rendering of a more detailed view of the device shown in FIG. 1;

FIG. 3 illustrates a cross section view of a portion of the connector of the device shown in FIG. 2.

### DETAILED DESCRIPTION OF THE INVENTION

### I. Definitions

The following term is intended to have the following general meanings as it is used herein.

1. Non-liquid: a compound does is not in a liquid state. For example, the compound can be in the form of gel, putty, paste, or the like.

2. Resilient and/or Resiliency: a quality that allows a device of the present invention to have the following characteristics. When the device is engaged to a seat belt system's female receptacle but not engaged with the seat belt system's male buckle, the device has sufficient stiffness that it would not fall onto the seat and/or floor; but instead, it would be in a relatively erect position. When the device is engaged both to the seat belt system's male buckle and female receptacle, the device has sufficient compliance that it would bend and form around a user's body (or an object such as a child safety seat). Once the device is disengaged from the seat belt system's male buckle but it is still connected to the seat belt system's female receptacle, the device recovers its relatively erect position allowing it to be easily located when needed.

### II. Resilient Seat Belt Extension Device

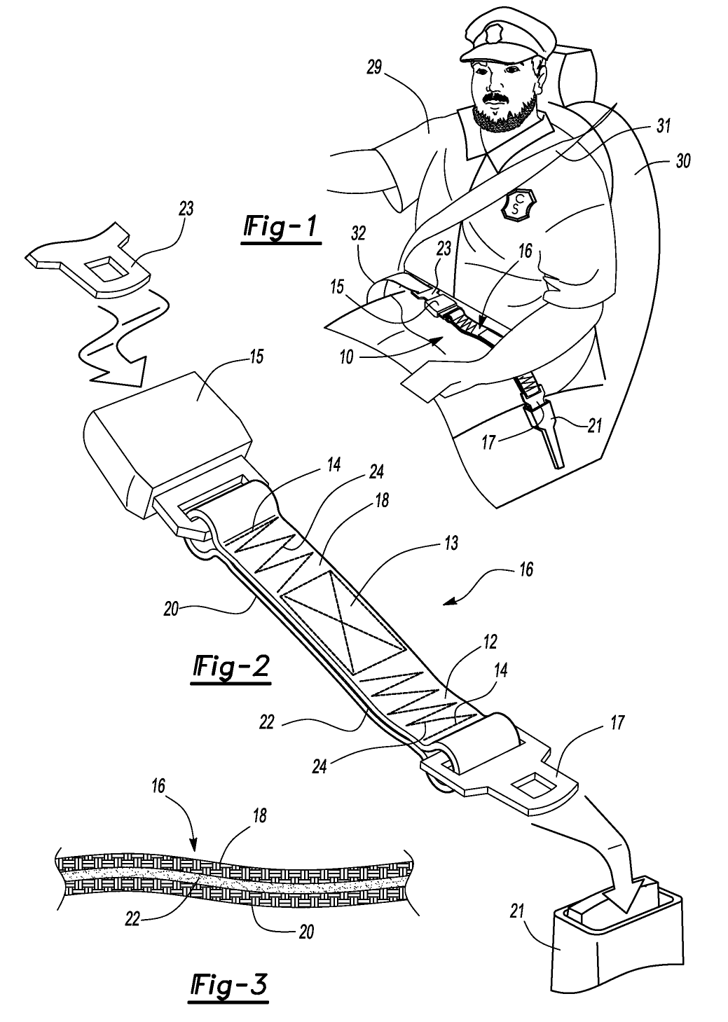

Referring to FIGS. 1-2, the resilient seat belt extension device 10 of the present invention includes a female receptacle 15 and a male buckle 17, and a resilient connector 16 having one end attached to the female receptacle 15 and another end attached to the male buckle 17, wherein the female receptacle is adapted to engage a seat belt system's male buckle 23 and the male buckle 17 is adapted to engage the seat belt system's female receptacle 21. The female receptacle 15 and the male bucket 17 can be any suitable art-disclosed female receptacles and male buckets used for conventional seat belt systems.

Referring to FIG. 1, the device 10 relocates the connection point of the seat belt system to a more central position for a user 29 (e.g., an occupant of a seat 30). When the device 10 is fully engaged with the seat belt system, the seat belt system's shoulder strap 31 and belt strap 32 are adjusted. It should be noted that the device 10 can be used with a variety of seat belt systems, including but not limited to a conventional three-point seat belt system (i.e., shoulder and belt straps), a conventional two-point seat belt system (i.e., belt strap), etc. The device 10 can also be used not just for an individual (not shown) sitting in the seat 30 but also for holding a child safety seat (not shown) onto the seat 30.

FIG. 2 shows a more detailed view of the device 10. Referring to FIG. 2, the connector 16 is formed by attaching both ends of an elongated material 12 together forming two layers (18, 20) of elongated material 12. This attachment can be achieved by any suitable art-disclosed means, including but not limited to, conventional seat belt stitching 13. The elongated material 12 can be constructed out of any art-disclosed suitable material used in the construction of conventional seat belts. For example, durable synthetic woven fabric can be used.

It is preferred that prior to attaching both ends of the elongated material 12 together, the elongated material 12 is attached to the female receptacle 15 and the male bucket 17 by looping the elongated material 12 through each of them (15, 17). The looping of the elongated material 12 through the female receptacle 15 is shown in FIG. 3. After the looping step, the female receptacle 15 and the male bucket 17 are fixedly attached to the elongated material 12 by art-disclosed attachment means. For example and as shown in FIG. 2, conventional seat belt stitching 14 is used to fixedly attach the female receptacle 15 to the elongated material 12.

Referring to FIG. 3, the connector 16 is further formed by placing a non-liquid compound 22 between the two layers (18, 20) of elongated material 12. The compound 22 is adapted to provide resiliency to the connector 16. The non-liquid compound 22 is placed in the areas between the two layers (18, 20) that are accessible (e.g., areas that not stitched up or the like). The compound 22 is placed preferably in at least 50%, more preferably in at least 70%, most preferably in at least 80% of the accessible areas between the two layers (18, 20). The compound 22 can be any suitable art-disclosed polyurethane, synthetic rubber compound, and a combination thereof in a non-liquid form. For example, Part No. PR1592, a polyurethane high hardness potting and molding compound manufactured by PRC DeSoto International, Inc. located in Glendale, Calif., USA, can be used as the compound 22. It should be noted that the compound 22 can be a mixture of suitable art-disclosed chemical components, wherein some of these components may be in liquid form, but the resulting compound 22 should be in a non-liquid form before the compound 22 is placed between the two layers (18, 20).

Referring to FIG. 2, after the compound has been placed between the two layers (18, 20) of elongated material 12, stitching 24 is then applied to the two layers (18, 20). The stitching 24 is not limited to the pattern shown in FIG. 2 and any suitable art-disclosed stitching pattern can be used. For example, the stitching 24 can be similar to the stitching 13 or the stitching 14 shown in FIG. 2, a simple “X” stitching pattern, a square, a stitching pattern, a rectangular stitching pattern, an oval stitching pattern, a circle stitching pattern, or a combination thereof, etc. The compound 22 contained within the two layers (18, 20) of the elongated material is then cured at a predetermined temperature for a predetermined amount of time. The predetermined temperature and predetermined amount of time in part depends on the compound 22. It is preferred that the predetermined temperature does not cause damage (e.g., physical damage or the like) to the elongated material 12. The cured compound 22 provides resiliency to the connector 16.

The total length and width of the device 10 can be any length and width suitable for the desired application. For example, the length can be from about 4″ to about 24″, from about 8.5″ to about 15″, and from about 9″ to about 12″. For example, the width can be from about 1.5″ to 3″, from about 1.75″ to about 2.75″, from 1.875″ to about 2.5″. It is generally preferred that the total length of the device be greater than about 8″.

A sleeve (not shown) can optionally be placed onto the connector 16 for additional support and/or for decorative purposes. The sleeve can be made to be either removable or not removable from the device 10. The sleeve can be constructed out of any art-disclosed suitable material. For example, in one embodiment, the sleeve has a width ranging from about 2″ to about 2.5″ and is constructed out of irradiated polyolefin (e.g., Part No. M23053/5, heat shrink tubing manufactured by Raychem located in Menlo Park, Calif., USA). The length of the sleeve depends upon the length of the connector 16 as it preferably shorter than the length of the connector 16. The sleeve is placed over the connector 16. Thereafter, heat is then applied to the sleeve to shrink it down for a snug fit around the connector 16.

Additional label and/or tag can optionally be attached onto the connector 16 for informational purposes via suitable art-disclosed means (e.g., stitching, adhesive, or the like).

### III. Method of Making the Resilient Seat Belt Extension Device

The present invention presents a method of making the above-described device comprising providing the female receptacle 15 adapted to engage a seat belt system's male buckle 23 and a male buckle 17 adapted to engage the seat belt system's female receptacle 21. The method also includes providing the elongated material 12 and looping the elongated material 12 through (i) an opening of the female receptacle 15 and (ii) an opening of the male bucket 17. The method further includes attaching ends of the elongated material 12 together to form the connector 16 having two layers (18, 20) of the elongated material 12. The method also includes fixedly attaching the female receptacle 15 to one end of the connector 16 and fixedly attaching the male buckle 17 to another end of the connector 16. It is preferred that stitching is used for such fixedly attachments.

The method further includes placing a compound 22 between the two layers (18, 20) of the elongated material 12 wherein the compound 22 is adapted to provide resiliency to the connector 16. After the compound 22 is placed between the two layers (18, 20) of the elongated material 12, the method includes attaching these two layers (18, 20) together via suitable art-disclosed attachment means such as stitching. The method also includes curing the compound 22 at a predetermined temperature until it can provide resiliency for the connector 16.

The present invention is not being limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

It is further to be understood that all numerical values are approximate and are provided for description only.

The following examples provided in accordance to the present invention are for illustrative purpose only and are not intended as being exhaustive or limiting of the invention.

### EXAMPLE I

An embodiment of the device of the present invention was made in accordance to the following:

A standard Ford® seat belt extender consisting of a connector having two layers of synthetic woven fabric material and is connected to a female receptacle and a male buckle (“items”) is provided. The total length of the extender is about 9.5″ and the width is about 1.875″. The connection between the connector and the items are formed by (i) looping the material through an opening of each of the items, (ii) stitching two ends of the material together to form the connector's two layers of material; and (iii) stitching the connector at locations near where the items are located thereby fixed in their attachment to the connector.

A polyurethane compound bearing Part No. PR1592 manufactured by PRC Desoto International, Inc. located in located in Glendale, Calif., USA is placed in the accessible areas between the two layers of material. Stitching is then applied to the two layers of material. The compound is cured at room temperature for about 8 hours. Upon completion of the curing process, the connector and the device has resiliency.

### EXAMPLE II

Same as Example I above except that the compound is cured at a predetermined temperature range from about 100 degree Fahrenheit (about 38 degree Celsius) to about 125 degree Fahrenheit (about 52 degree Celsius) for a predetermined time from about 2 hours to about 4 hours.

What is claimed is:

1. A resilient seat belt extension device comprising:
A female receptacle adapted to engage a seat belt system's male buckle;
A male buckle adapted to engage a seat belt system's female receptacle;
A resilient connector fixedly attached to the female receptacle on one end and the male buckle on another end; wherein the connector is formed by the following steps:
(a) Attaching ends of an elongated material together to form the connector with two layers of elongated material;
(b) Placing a non-liquid compound between the two layers of elongated material wherein the compound is adapted to provide resiliency to the connector;
(c) Attaching the two layers of elongated material together; and
(d) Curing the compound at a predetermined temperature.

2. The device of claim 1 wherein stitching are used before step (a) to fixedly attached the female receptacle to the connector and the male buckle to the connector.

3. The device of claim 2 wherein the compound is placed in accessible areas between the two layers of elongated material.

4. The device of claim 3 wherein the compound is placed in at least 80% of the accessible areas between the two layers of elongated material.

5. The device of claim 2 wherein the stitching is conventional seat belt stitching.

6. The device of claim 1 wherein the compound is selected from a group consisting of polyurethane, synthetic rubber, and a combination thereof.

7. The device of claim 1 wherein the compound is in a liquid form but was transformed into a non-liquid form prior to step (b).

8. The device of claim 1 wherein the compound is polyurethane.

9. The device of claim 1 wherein the compound is Part No. PR1592 manufactured by PRC DeSoto International Inc.

10. The device of claim 1 wherein stitching is used to attach the two layers of elongated material together in step (c).

11. The device of claim 10 wherein pattern of the stitching is selected from a group consisting of a “X” stitching pattern, a square stitching pattern, a rectangular stitching patter, an oval stitching pattern, a circle stitching pattern, and a combination thereof.

12. The device of claim 1 wherein the elongated material is a synthetic woven fabric.

13. The device of claim 1 wherein the predetermined temperature does not cause physical damage to the elongated material.

14. The device of claim 1 wherein the predetermined temperature is room temperature.

15. The device of claim 1 wherein the predetermined temperature ranges from about 100 degree Fahrenheit to about 125 degree Fahrenheit.

16. The device of claim 1 wherein a sleeve is placed onto the resilient connector after step (d).

17. The device of claim 16 wherein the sleeve is removable.

18. The device of claim 1 wherein the total length of the device is greater than about 8 inches.

19. The device of claim 1 wherein the width of the device ranges from about 1.75 inches to about 2.75 inches.

20. A method of making a resilient seat belt extension device comprising:
Providing a female receptacle adapted to engage a seat belt system's male buckle;
Providing a male buckle adapted to engage the seat belt system's female receptacle;
Providing an elongated material;
Looping the elongated material through an opening of the female receptacle;
Looping the elongated material through an opening of the male buckle;
Attaching ends of the elongated material together to form the connector having two layers of elongated material;
Fixedly attaching the female receptacle at one end of the connector and the male buckle at another end of the connector;
Placing a non-liquid compound between the two layers of elongated material wherein the compound is adapted to provide resiliency to the connector;
Attaching the two layers of elongated material together; and
Curing the compound at a predetermined temperature.
